(19) United States
(12) Patent Application Publication
(10) Pub. No.: US 2002/0059106 A1
(43) Pub. Date: May 16, 2002

(54) Consumable goods and services providing system

(76) Inventor: Masayuki Tani, Yokohama City (JP)

Correspondence Address: JACOBSON HOLMAN PLLC, 400 SEVENTH STREET N.W., SUITE 600, WASHINGTON, DC, 20004, US

(21) Appl. No.: 09/853,036

(22) Filed: May 11, 2001

(30) Foreign Application Priority Data
May 12, 2000 (JP) P2000-141017
Apr. 27, 2001 (JP) P2001-131220

(51) Int. Cl. G06F 17/60; G06F 15/16

(52) U.S. Cl. 705/26; 709/203

(57) ABSTRACT

A consumable goods providing system is provided in which consumable goods or substitute recycling consumable goods can be quickly and efficiently provided.

The consumable goods providing system in which use information associated with a printing machine connected to a LAN is stored in a file via a server that manages it, and a server on a consumable goods providing side obtains the use information within the file via a internet to presume a delivery schedule of the consumable goods of the printing machine and, upon a delivery schedule date, to conduct a forwarding procedure of the consumable goods or the substitute recycling consumable goods with an equivalent level in terms of a recycling number to the consumable goods that are scheduled to be delivered.

### BACKGROUND OF THE INVENTION

(i) Field of the Invention

The present invention relates to a system for providing consumable goods and services of an apparatus that connects to a network, more particularly to a consumable goods providing system that can quickly and efficiently provide the consumable goods.

(ii) Description of the Related Art

Conventionally, for example, when a consumable goods of a printing machine (printer) that was used in an office was consumed up, it has been carried out that a person in the office that became aware of this consumption informed a merchant to order a cartridge hereto.

Furthermore, with regard to a system for automating an order of the consumable goods, there is “an automatic order system” in Japanese Patent Application Laid-Open No. 315025/1996 disclosed on Nov. 29, 1996 (an applicant: Ricoh CO. LTD., an inventor: Souji Hujitani).

The above invention is aimed at alleviating order works by ordering the consumable goods that have been run out at each terminal with a facsimile communication via a transit device connected to a network.

Recently, for an environment protection, a method for recycling has been carried out in which a cartridge is re-used at plural times by exchanging the toner thereof. However, the number of re-using of it has been pre-determined, depending upon a type of the cartridge, and thus it is necessary to recycle it while managing this number.

However, in the conventional automated order system set forth above, since an order is to be made after the consumable goods have been used up, a merchant can not quickly provide substitutes, there is no much difference between this ordering and an order by a person, and accordingly the problem existed that it was still not said to be efficient.

Moreover, in case of the recycling method, since the merchant needed to manage the number of re-stuffing in the cartridge to provide the consumable goods, the problem existed that the recycling business was difficult to efficiently conduct.

### SUMMARY OF THE INVENTION

An objectivity of the present invention is to provide a consumable goods providing system that can quickly and efficiently provide the consumable goods or the suitable substitute recycling consumable goods.

The present invention can quickly and efficiently provide the consumable goods and services, since in the consumable goods and services providing system a server on a consumable goods and services providing side is to obtain use information by a network connection to a server that manages the use information of the apparatus being connected hereto to presume a delivery schedule of the consumable goods or services of the above apparatus, and, upon the above delivery schedule date, to conduct a forward procedure of the consumable goods or services.

The present invention can quickly and efficiently provide the suitable substitute recycling consumable goods, since, in the consumable goods providing system, the server on the consumable goods providing side is to obtain use information by a network connection to a server that manages the use information of the apparatus being connected hereto, to presume a delivery schedule of the consumable goods of the above apparatus, and, upon the above delivery schedule date, to conduct a forward procedure of the suitable substitute recycling consumable goods with an equivalent level in terms of the recycling number to the consumable goods that are scheduled to be delivered.

Furthermore, the present invention can more efficiently provide the suitable substitute recycling consumable goods, since, in the above-mention consumable goods providing system, in case that no suitable substitute recycling consumable goods with the equivalent level are present at the server on the consumable goods providing side, the server on the consumable goods providing side is to prepare the suitable substitute recycling consumable goods with the equivalent level from the merchant who is in the same line of business and is affiliated with it.

Furthermore, the present invention can efficiently provide the substitute recycling consumable goods, since, in the above-mention consumable goods providing system, in case that no substitute recycling consumable goods with the equivalent level are present at the server on the consumable goods providing side, the server on the consumable goods providing side is to prepare the same type of the substitute recycling consumable goods with nearly the same level.

Moreover, the present invention makes a process management easy and can quickly and efficiently provide the suitable substitute recycling consumable goods, since, in the above-mention consumable goods providing system, to the consumable goods is to be attached a record medium such as an ID tag or a bar cord storing apparatus information, customer information, and recycling number information.

Furthermore, the present invention can quickly and efficiently provide the consumable goods, since the consumable goods providing system comprises: a printer supervisory server that, upon obtaining information of a printer situation from a network printer, prepares and transmits an electronic filing document associated with the above printer based on the information; and the server on the consumable goods providing side that receives the electronic filing document transmitted from this printer supervisory server to analyze contents of the electronic filing document, and that if the above analyzed contents are related to the consumption of the consumable goods at the printer, conducts an arrangement process of the above consumable goods.

In addition, the present invention can quickly and efficiently conduct a maintenance of the printer in addition to the provision of the consumable goods, since, in the above-mentioned consumable goods providing system, in the information of the printer situation is included information of a serviceman call error at the printer, the server on the consumable goods providing side correspondingly stores the printer and a service station that is located near it, and in case that the analyzed contents are the serviceman call error, transmits a request of a maintenance of the printer to a terminal apparatus managing the service station that is located near the above printer.

### BRIEF DESCRIPTION OF THE DRAWINGD

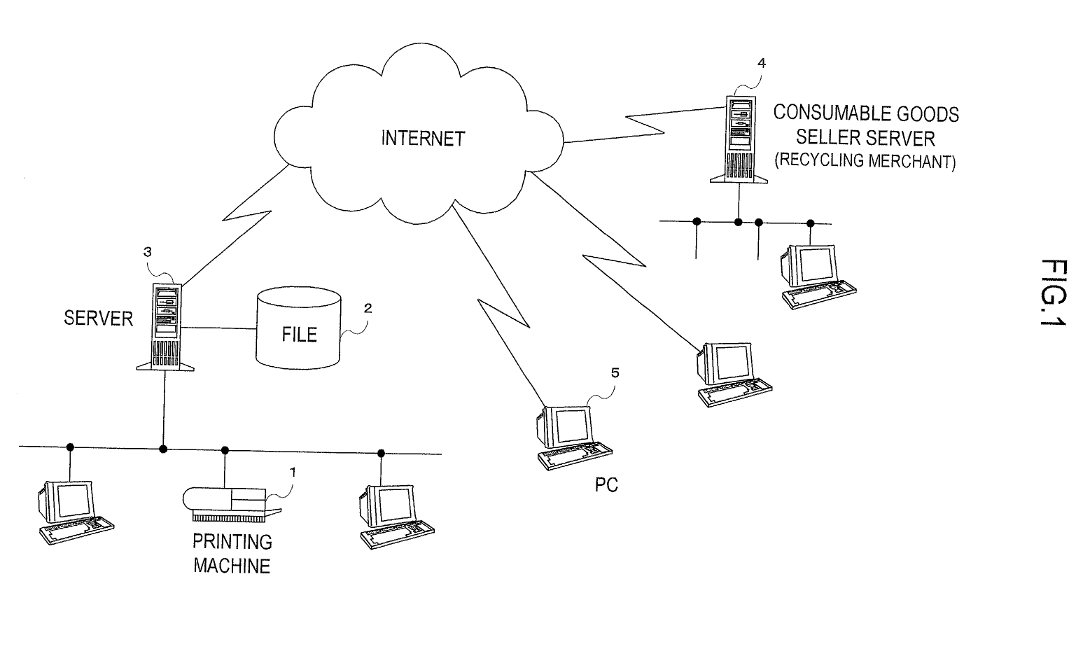

FIG. 1 is a block diagram of a first consumable goods providing system relating to an embodiment of the present invention.

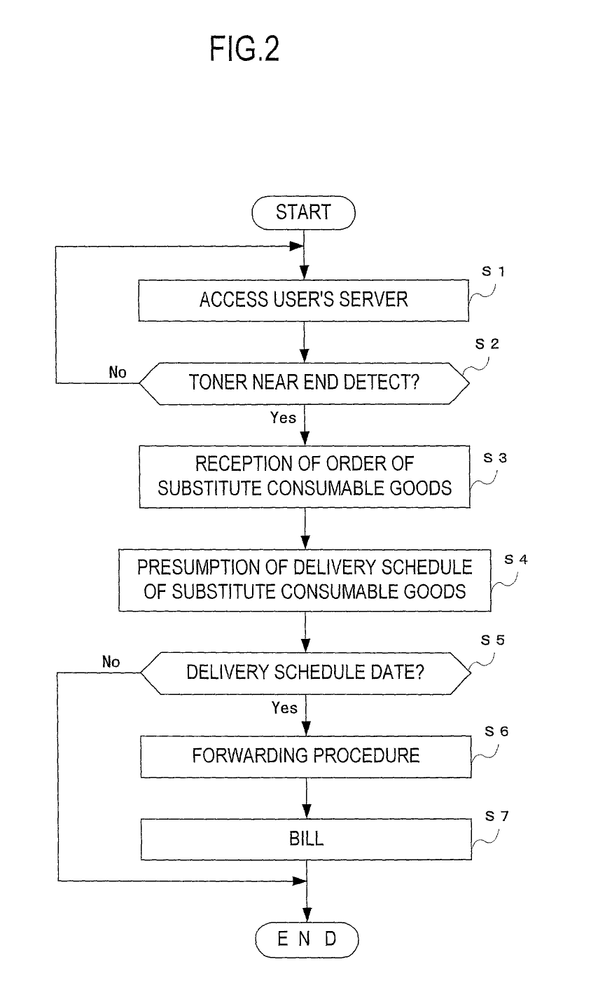

FIG. 2 is a flowchart diagram illustrating a process of a first consumable goods providing system relating to an embodiment of the present invention.

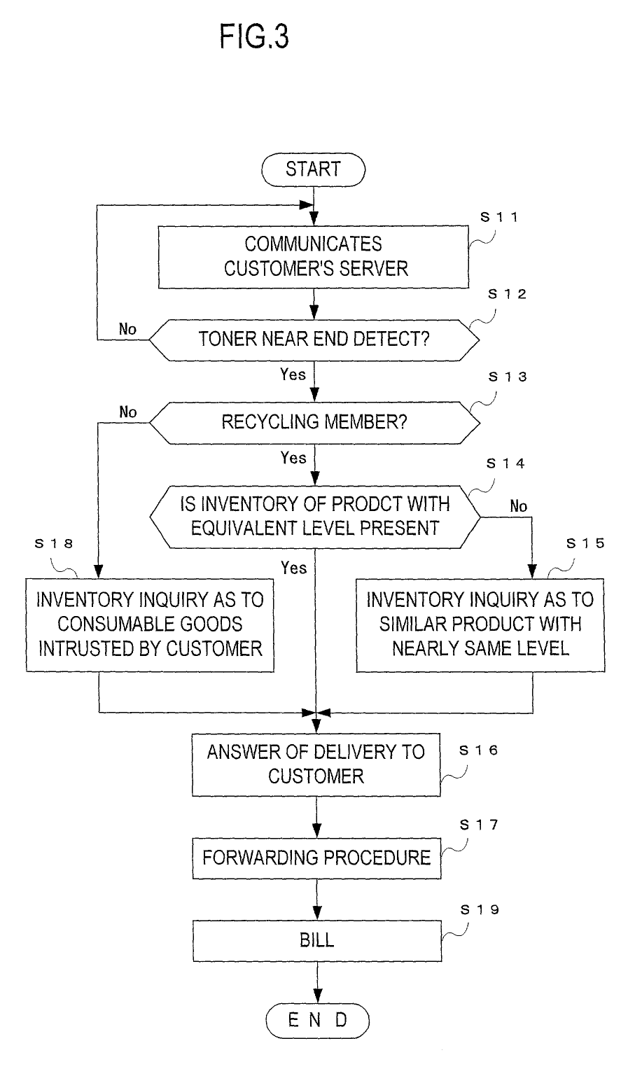

FIG. 3 is a flowchart diagram illustrating a process of a second consumable goods providing system relating to an embodiment of the present invention.

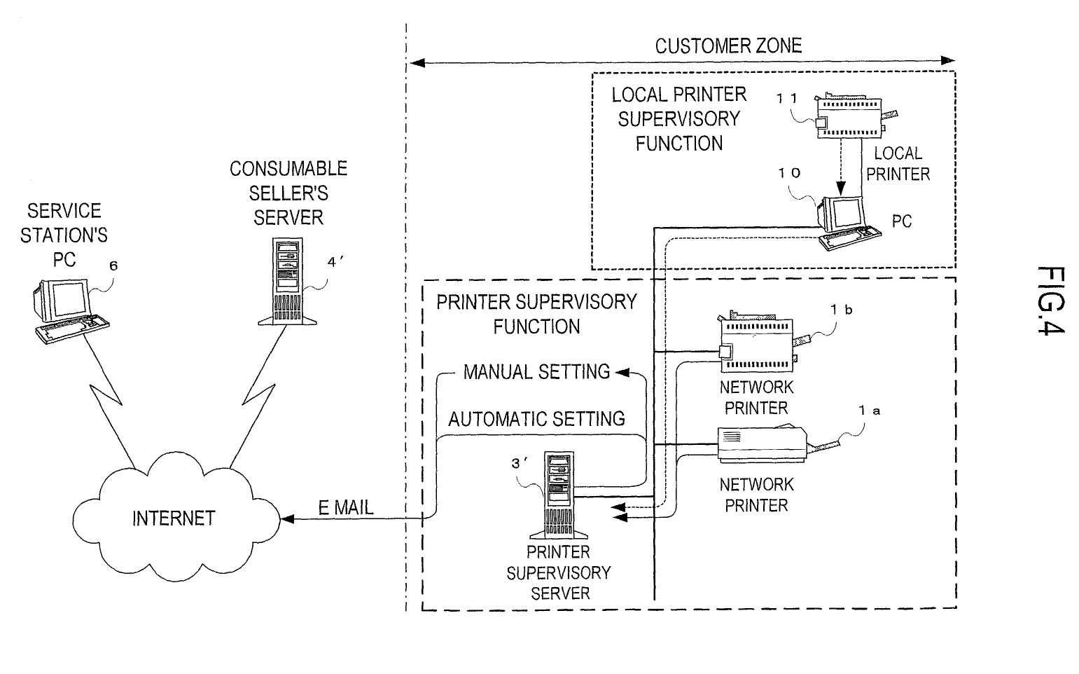

FIG. 4 is a system block diagram of a third consumable goods providing system relating to an embodiment of the present invention.

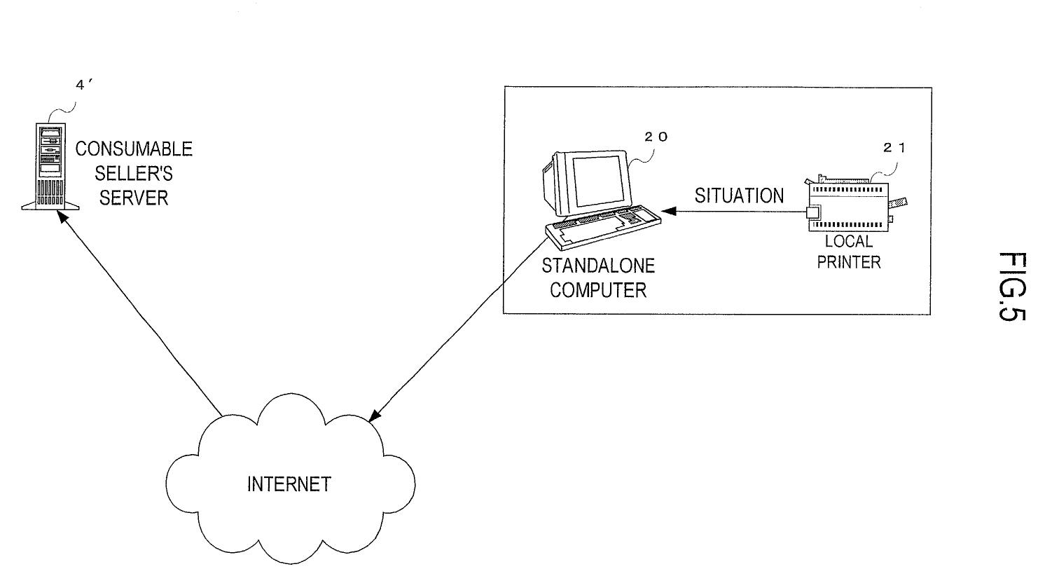

FIG. 5 is a system diagram of a fourth consumable goods providing system relating to an embodiment of the present invention.

### DESCRIPTION OF REFERENCE NUMERALS

1: Printing Machine, 1a, 1b: Network printer, 2: File, 3: Server, 3′: Printer supervisory Server, 4: Server, 4′: Consumable goods seller's server, 5: PC, 6: Service station's PC, 10: PC, 11: Local printer, 20: Standalone PC, 21: Local printer

### DETAILED DESCRIPTION OF THE PREFERRED EMBODIMENT

Hereinafter, an embodiment of the present invention will be explained, referring to the drawings.

In a first consumable goods providing system relating to an embodiment of the present invention, a server on a consumable goods providing side is to obtain use information by a network connection to a server that manages use information of an apparatus being connected hereto to presume a delivery schedule of the consumable goods of the above apparatus, and upon the above delivery schedule date, to conduct a forward procedure of the consumable goods, and accordingly, the consumable goods can be quickly and efficiently provided.

Furthermore, in a second consumable goods providing system relating to an embodiment of the present invention, the server on the consumable goods providing side is to obtain use information by a network connection to a server that manages use information of an apparatus being connected hereto to presume a delivery schedule of the consumable goods of the above apparatus and, upon the above delivery schedule date, to conduct a forward procedure of the suitable substitute recycling consumable goods with an equivalent level in terms of the recycling number to the consumable goods that are scheduled to be delivered, and accordingly, the suitable substitute recycling consumable goods can be quickly and efficiently provided.

The first consumable goods providing system (a first system) relating to the embodiment of the present invention will be explained by use of FIG. 1. FIG. 1 is the block diagram of the first consumable goods providing system relating to the embodiment of the present invention.

The first system, as shown in FIG. 1, is constructed of, as a user side a printing machine (printing apparatus or printer) 1 being connected to a LAN (Local Area Network), a memory device (file) 2 storing information in the above LAN, a server that is connected to the above LAN and simultaneously connected to a internet, as a consumable goods seller side a server 4 being connected to the internet, and as the other user side a personal computer (PC) being connected to the internet.

Next, each component of the first system will be specifically explained.

The printing machine 1 notifies the server 3 via the LAN of use amount information of the consumable goods such as the toner and so forth. Herein, as use amount information, there are a toner near end that informs that the toner will be used up soon, a toner empty that informs that the toner has been used up, and so forth.

In FIG. 1, only one printing machine 1 connected to the LAN is shown, but originally, a plurality of the printing machines that are connected to the LAN have been considered.

The server 3 receives use amount information of the consumable goods being transmitted from the printing machine 1 to store it in the file 2. The server 3, which manages each of the plurality of the printing machines 1 being connected to the LAN respectively, manages the use amount information of the consumable goods received from each printing machine 1 printing machine by printing machine.

Furthermore, for accessing by the server on the consumable goods seller side 4, the server 3 outputs to the server 4 information stored in the file 2.

By the control of the server 3, the file 2 stores the use amount information of the consumable goods on each printing machine 1, and simultaneously retrieves the information to be stored to output it to the server 3.

In information to be stored, are included address information of the printing machine, type information of the printing machine, use amount information of the consumable goods of the printing machine in addition hereto, and so forth.

The consumable goods seller's server 4, which manages each user's printing machine 1 via each user's server 3, gets an order of the consumable goods responding to the status of the printing machine 1 to forward the consumable goods.

Specifically, the server 4 carries out the process shown in FIG. 2. FIG. 2 is the flowchart diagram illustrating the process of the first consumable goods providing system relating to the embodiment of the present invention.

As shown in FIG. 2, the server 4 accesses each user's server (S1) to determine whether there was any toner near end detected at the printing machine 1 (S2). If the toner near end has not been detected (in case of No), the process then returns to S1.

In addition, the server 4 is to periodically access the server 3, but it is acceptable that the server 4 is adapted to get the report from the server 3 only in case that any change in information on the consumable goods occurred.

Moreover, the server 4 accesses data of the file 2 via the server 3, and security means are used in this access. Namely, the server 4 executes an access to the file 2 with the predetermined means (a protocol, an authentication) to obtain information such as customer information, a type name of the printing machine, a degree to which the consumable goods have been consumed, and so forth.

Upon detecting the toner near end (in case of Yes), at this moment, the server 4 gets an order on the substitute consumable goods (S3). And, the server 4 presumes from a past record of the above printing machine 1 a delivery schedule of the substitute consumable goods so that this presumed date is before the date at which it will become to be in the toner empty (S4).

In addition, it is thought that the presumed delivery schedule date is to be the date that can be obtained by subtracting the days necessary for forwarding from the days during which until now the printing machine has become to be in the toner empty from being in the toner near end most shortly. Also the average days are calculated during which until now the printing machine has become to be in the toner empty since the toner near end was detected, and it is also thought that the schedule date is to be before the date obtained by subtracting the days necessary for forwarding from the calculated average days.

And, a determination is made (S5) as to whether or not there is any printing machine 1 that has reached the delivery schedule date presumed in the process S4, and if no printing machine 1 is present that has reached the delivery schedule date (in case of No), the process finishes.

If the printing machine 1 is present that has reached the delivery schedule date (in case of Yes), the forwarding procedure is carried out (S6), and the charge is billed (S7). Thereafter, money is to be received.

Furthermore, in order to carry out the process set forth above, the server 4 is to possess information such as an address of a user's printing machine, a customer name, a model of the printing machine, a delivery site, a forwarding destination of the delivery document, a forwarding destination of the bill and so forth.

In accordance with the first system, in case that the user's printing machine 1 is connected to the LAN, if information of the toner near end is stored in the file 2 via the server 3 from this printing machine 1, it is possible that the consumable goods seller's server 4 periodically accesses the user (customer)'s server 3 to obtain information within the file 2 associated with the printing machine 1 that has become to be in the toner end to presume from this toner near end the delivery schedule date of the consumable goods and to forward it, and accordingly, the advantage is effected that the procedure of getting an order and forwarding of the consumable goods is quickly executed and simplified, furthermore the customer can get the consumable goods such as the toner cartridge and so forth before the toner empty, and a disturbance of a flow of the customer's business does not occur.

Next, the second consumable goods providing system (a second system) relating to the embodiment of the present invention will be explained.

The second system is basically the same as the first system shown in FIG. 1, but it differs from the second one in that the consumable goods seller is a recycling merchant and in the process at the server accompanied by it.

In the second system, in case that the toner of the customer's printing machine has run out, the consumable goods seller (the recycling merchant) is to supply to the customer the other toner cartridge than the cartridge of which toner has been replaced, and the suitable substitute recycling consumable goods can be quickly and efficiently provided.

However, the number of the recycling during which the toners of the cartridge can be replaced has been determined in advance, depending upon the model thereof, and the consumable goods seller's server 4 or the customer's server 3 manages the “recyclable number” on each toner cartridge.

For example, if the server 4 is to manage the “recyclable number” on each cartridge, it means that the server 4 manages an address of the printing machine, a type of the printing machine, a type of the toner cartridge, and the recyclable number thereof on each customer.

Accordingly, in case that the customer's toner (consumable goods) has become to be in the toner near end, the suitable substitute recycling consumable goods are to be prepared from the inventory, and with regard to the cartridge of which toner became to be in the toner near end, the same type of the cartridge (product with the equivalent level) with the number that is the recyclable number minus one (1) is to be selected to provide it to the customer.

In case that no product with the equivalent level is in the inventory, the same type of the product with nearly the same level is to be provided.

The second system will be specifically explained by use of FIG. 1 and FIG. 3. FIG. 3 is the flowchart diagram illustrating the process in the second consumable goods providing system relating to the embodiment of the present invention.

When the printing machine 1 notifies the customer's server 3 via the LAN of the use information of the consumable goods (the toner near end or the toner empty), the server 3 causes the file 2 to store this information on each printing machine 1.

The consumable goods seller (recycling merchant)'s server 4 communicates the customer's server 3 via the internet to obtain the use amount information of the consumable goods stored in the file 2 (S11). In addition, in a similar manner to the first system, it is acceptable that the server 4 is adapted to get the report from the server 3 only in case that any change in information on the consumable goods occurred.

Also in the second system, an access of the server 4 to the server 3 and to the file 2 is carried out with security means.

When the server 4 detects the toner near end from among the obtained information associated with the consumable goods (S12), it determines whether the information associated with the consumable goods belongs to a recycling member (a member who is destined to carry out recycling of the consumable goods by entering into a contract with the consumable goods seller in advance) or a non-recycling member (S13).

In case of the recycling member (in case of Yes), the server 4 inquires for the inventory information as to whether or not the inventory of the product (product with the equivalent level) is present that has been recycled times of the equivalent number to the cartridge that the recycling member possesses (S14).

Herein, in case that even though the server 4 inquired for its own inventory, no inventory of the above product is present, to a merchant, if he/she is in the same line of business and affiliated with it, the server 4 inquires for the inventory information of the merchant. FIG. 1 illustrates that the PC 5 is a server of the merchant who is in the same line of the business and affiliated with it. In case that this inventory information indicates that not above product is present, an inquiry is made as to the inventory of the similar product with nearly the same level (the same kind of the product) (S15). BY this inquiry, if the product with the equivalent level or the similar product with nearly the same level is present, the delivery date is answered to the customer (S16) to carry out the forwarding procedure (S17).

Furthermore, if the consumable goods of the recycling member have completed recycling of the specified number, the server 4 makes a reference as to for and against an arrangement of a new product. In case that the consumable goods have completed recycling of the specified number, if an agreement is made that the above member needs a new product, the server 4 refers this information to arrange the new product.

In the process S13, if the information associated with the consumable goods does not belong to a recycling member (in case of No), namely belongs to the non-recycling member, an inquiry is made as to the inventory of the consumable goods entrusted by the customer, if the inventory is present, the delivery date is answered to the customer, and if not, an inquiry is made to the customer as to whether he/she accepts a new product as the substitute. In case that the non-recycling member wishes a new product for the substitute, the delivery date of the above new product for substitute is answered according to his/her answer.

In case that the non-recycling member wishes the substitute recycling consumable goods, the consumable goods seller requests him/her to send the used consumable goods back, and answers the delivery date of the suitable substitute recycling consumable goods to the customer based on his/her answer to this request.

It should be construed by the recycling member and the non-recycling member that, upon answering the delivery date, a buyer-seller contract has been completed.

The obtained information on the consumable goods of the recycling member and the non-recycling member is stored in the consumable goods seller's server 4, and used for presumption of the date when the next consumable goods will be required. Moreover, the server 4 updates for the user's LAN management server 3 the demand prediction that when and to which printing machine 1 the consumable goods will be forwarded.

The consumable goods seller forwards to the predetermined site the product that the customer requests (S17). For example, it is acceptable to forward it to a company, a factory and an office, and forwarding and payment settlement are also possible at convenient stores.

Furthermore, the consumable goods seller bills a charge to a customer in a pre-determined manner and at a predetermined time (S19).

The customer pays money for the consumable goods seller according to the bill.

In accordance with the second system, the suitable substitute recycling consumable goods of which quality is equivalent to the product can be adapted to be provided to the customer, if he/she is a recycling member, and accordingly, the advantage is effected that the provision of the suitable substitute recycling consumable goods can be quickly and efficiently made.

Next, the consumable goods seller collects the used consumable goods or the toner near end consumable goods according to the customer request.

To the collected consumable goods is attached a customer's ID tag at the stage when they have been received at a warehouse of the consumable goods seller.

What is called an ID tag is a contact-less data carrier with combination of microwaves and power-saved tips, and in this tag are stored the following information. By attaching such information as the ID tag to the consumable goods, the above consumable goods can be easily return to the original customer. In addition, it makes a process management easy, and allows the suitable substitute recycling consumable goods to be easily separated to realize a quick forwarding.

A record medium such as a bar cord is available instead of ID tag.

In the ID tag is stored the information such as an address information of the printing machine 1, a customer's name, a type of the printing machine, a recycling number of the cartridge and so forth.

The information stored in the ID tag is registered and stored in a product master file of the server 4 at the time of the delivery, of determination as to whether or not recycling is possible and of addition to the inventory of the consumable goods that have been processed for recycling.

In the product master file of the server 4 is stored the information such as a customer's name, a registered member (recycling member) or not, payment settlement terms, a designation of a delivery site, how to process in case that recycling is impossible (return, abandoning, the document for the reason being necessary or not), a new product being necessary or not in case of maturity of the recycling number, a forwarding destination of a delivery note, a forwarding destination of a bill, a model name of a printing machine (printer) that a customer possesses, and so forth.

According to the agreement between the customer and the consumable goods seller, this inventory situation is disclosed in the file for specific customers by a customer accessing, and the customer can refer the recycling situation of the consumable goods, the scheduled delivery date, the past order, and the reception record from this disclosed contents.

Herein, a franchise mechanism using the second system will be explained.

For a franchiser promoting the above business are gathered many franchisee that really conduct the recycling business in this system.

One group is formed out of the franchiser and the many franchisees, and a purchase is made within the above group. As a result, the consumable goods that are recycled become the group's property.

Furthermore, in case that no product with the equivalent level is present within one franchisee, an inquiry to the other neighboring franchisees is to be made as to whether the product with the equivalent level is present, and in case that no product with the equivalent level is present within several franchisees, an inquiry is to be made as to whether the similar product with nearly the same level is present, and accordingly, efficiency in re-usage of the suitable substitute recycling consumable goods is to be enhanced.

In addition, the PC 5 in FIG. 1 indicates the server of the other neighboring franchisee that is a reference.

In addition, in the embodiment of the present invention, an explanation has been made, the toner being taken as an example, but the other consumable goods than this, and the parts such as that deteriorate in their quality, which are nearly categorized as the consumable goods, can find application in the consumable goods providing system.

Next, the third consumable goods providing system relating to the embodiment of the present invention will be explained by use of FIG. 4. FIG. 4 is a system block diagram of a third consumable goods providing system relating to an embodiment of the present invention.

The third consumable goods providing system (a third system) relating to the embodiment of the present invention, as shown in FIG. 4 is basically constructed of network printers 1a and 1b being connected to the LAN (Local Area Network), a personal computer (PC) 10 that connects to the above LAN, a local printer 11 that connects only to the above PC 10, a printer supervisory server 3′ that inputs information associated with a situation of the above-mentioned printer to transmit an electronic mail for ordering necessary consumable goods via the internet, a consumable goods seller's server 4′ that receives this electronic mail to conduct an order process of the consumable goods, and a service station's PC 6.

In addition, the network printers 1a and 1b, the PC 10, and the printer supervisory server 3′ that connect to the LAN is to construct a customer zone as a unit of one company (customer) and so forth, and normally a plurality of these units are connected to the internet. Moreover, the service stations PC 6 are to be located at each area's service station, and a plurality of the service stations PC 6 are connected to the network.

Each component of the third system is specifically explained.

To a request by the printer supervisory server 3′, the network printers 1a and 1b output a situation of the printer to the printer supervisory server 3′ via the LAN by use of a SNMP (Simple Network Management Protocol). The information that the network printers 1a and 1b output is information associated with a toner (a toner near end and a toner empty), information associated with a paper (a paper shortage and a paper clogging), information associated with a maintenance (a serviceman call error), and so forth. The local printer 11 also outputs the situation of the printer to the PC 10 being connected to hereto.

The PC 10 outputs the situation of the printer input from the local printer 11 to the printer supervisory server 3′ via the LAN by use of a SNMP (Simple Network Management Protocol) and so forth.

For this end, in the PC 10 has been built a program for responding to a polling (Get Request) or a means for sending the electronic mail by the printer supervisory server 3′ by use of the SNMP Protocol, for notifying and responding the situation of the local printer 11.

The printer supervisory server 3′ polls (Get Request) the situation of the network printer and so forth by use of the SNMP Protocol and so forth. In case that, as the Get Response in response thereof, information of the printer situation associated with a alarm relative to a toner and so forth is present, into the printer supervisory server 3′ is input the information of the printer situation from the network printers 1a and 1b, or the PC 10 via the LAN.

To this information of the printer situation, the printer supervisory server 3′ automatically prepares contents of the situation of the above printer as an electronic mail (automated preparation) to transmit it to the consumable goods seller's server 4′ via the internet.

The electronic mail from the printer supervisory server 3′ is to be transmitted, for example, with a dial-up connection, and a transmission setting can be conducted automatically or manually.

In the contents of the electronic mail are included an address of a forwarding destination (address of the consumable goods seller's server 4′), a host name or an IP address for identifying the printer, a name of a printer, a production number of a printer, and information of a printer situation in addition hereto.

The consumable goods seller's server 4′, which is a server on the consumable goods providing side, receives the electronic mail from the customer's printer supervisory server 3′ to analyze the contents of the electronic mail and to execute a process responding to the contents. For example, if the electronic mail is the mail associated with an order of the cartridge, the consumable goods seller's server 4′conducts an order reception process of the consumable goods and conducts an arrangement process. Furthermore, It is possible to conduct the processes shown in FIG. 2 and FIG. 3. In this case, an access to the user's server in FIG. 2 (S1) or an access to the customer's server in FIG. 3 (S11) becomes a reception of the electronic mail and an analysis of the mail contents.

The consumable goods seller's server 4′ receives with the electronic mail not only the toner information but also the other information such as a paper shortage, a paper clogging, a serviceman call error and so forth. In case of the paper shortage, the consumable goods seller's server 4′conducts a forwarding process of the paper on the premise that the order of the paper has been placed by this electronic mail.

Additionally, in case of the serviceman call error, the consumable goods seller's server 4′, which possesses a table for pre-correspondingly managing a printer location site and a service station site, retrieves the service station that is located near the printer, referring to this table, to transmit a maintenance request to the terminal apparatus (service station's PC) 6 that manages the above service station with the electronic mail via the internet. In addition, the service station's PC 6 is typically located at the service station.

The service station's PC 6 receives the maintenance request from the consumable goods seller's server 4′ with the electronic mail to display it on the display screen. A service station's serviceman is to visit the printer that needs the maintenance responding to the electronic mail to conduct a maintenance work.

Next, the process operation in the third system will be explained.

At first, the printer supervisory server 3′periodically polls (SNMP Get Request) via the LAN the PC 10 to which the network printers 1a and 1b or the local printer 11 connect. To the, the printer supervisory server 3′receives and stores information of the printer situation from the apparatus.

What is called this information of the printer situation is error information such as the toner near end, the toner empty, the serviceman call error, and so forth. In addition, the printer supervisory server 3′ prepares the electronic mail addressed to the consumable goods seller's server 4′ based on the received information of the printer situation. In the above electronic mail are included information for specifying an originator, a type of and a location site of the printer, and information of the printer situation that is error information.

This electronic mail is automatically prepared by extracting a necessity from the information of the printer situation received from the printer and so forth with the program within the printer supervisory server 3′. Furthermore, the printer supervisory server 3′ automatically or manually transmits the automatically prepared electronic mail to the consumable goods seller's server 4′ via the internet.

The reason why the printer supervisory server 3′ does not receive the SNMP by the consumable goods seller's server 4′ but the electronic mail is caused to be transmitted from the printer supervisory server 3′ to the consumable goods seller's server 4′ is to enhance a security for the customer's network.

If the printer situation is associated with a consumption of the consumable goods such as the toner, the printer paper, or the like, the consumable goods seller's server 4′ that received the electronic mail conducts the order reception process of the consumable goods and the forwarding process on the premise that the order of the consumable goods that correspond hereto has been received. Furthermore, if the printer situation is associated with the serviceman call error, the consumable goods seller's server 4′ transmits the electronic mail of the maintenance request to the service station's PC 6 that is located near the location site of the above printer.

In accordance with the third system, not only to the network printer being connected to the LAN within a customer's company, but also to the local printer 11 that connects to the PC 10 being connected to the LAN, the printer supervisory server 3′ manages the situation of the toner, the situation of the paper and the situation of the maintenance, if an error is present, obtains information of the printer situation to transmit the electronic mail to the consumable goods seller's server 4′, the consumable goods seller's server 4′ conducts an arrangement of the consumable goods and an arrangement of the maintenance, and accordingly, the advantage is effected that consumable goods can be quickly provided and furthermore the maintenance of the printer also can be quickly conducted.

Next, the fourth consumable goods providing system (a fourth system) relating to the embodiment of the present invention will be explained by use of FIG. 5. FIG. 5 is a system block diagram of a fourth consumable goods providing system relating to an embodiment of the present invention. The fourth system, as shown in FIG. 5 is basically constructed of a standalone PC 20, a local printer 21 that connects hereto, and the consumable goods seller's server 4′being connected via the internet.

In addition, in FIG. 5 only one combination of the standalone PC 20 and the local printer 21 is depicted, but originally, it has been considered that a plurality of the standalone PCs are connected via the internet, and that to each PC 20 are connected local printers 21 respectively. In the fourth system, for an ink shortage of a ink cartridge at the local printer 21 that connects to the standalone PC 20, the standalone PC 20 is to transmit to the consumable goods seller's server 4′ the electronic mail for ordering the substitute at the moment when this ink shortage has occurred. Namely, it is a pre-condition that a user of the standalone PC 20 has pre-agreed to utilization of the present system.

The local printer 21 outputs information of the printer situation to the standalone PC 20 being connected hereto.

Herein, what is called information of the printer, for example, is information associated with the ink shortage of the ink cartridge if the local printer 21 is an ink jet printer, and is information associated with the toner shortage of the toner cartridge if it is a laser beam printer.

The standalone PC 20 inputs the information of the printer from the local printer 21 to prepare (generate) and transmit the electronic mail for destination of the consumable goods seller's server 4′ based on the above information.

For this end, it is necessary that the standalone 20 registers users to the consumable goods seller's server 4′ in advance, and builds in with a download, a CD-ROM, or the like a program for an automatic electronic mail preparation and transmission.

As the user registration, in addition to the mail address, are set a name of a printer, a production number, how and where the consumable goods are received, and so forth. For example, in case that the reception site of the consumable goods is set to be a convenient store, it is to be pre-determined that at which store in which area the consumable goods are received.

In the contents of the electronic mail are included an address of a forwarding destination (address of the consumable goods seller's server 4′), a mail address of the standalone PC 20, a name of a printer for identifying a printer being connected, a production number of a printer, and information of a printer situation in addition hereto. Since the name of the printer and the production number have already registered by the prior user registration, there is no need for including this information in the transmission mail, but, since there might be the case in which a user uses a plurality of printers, this information is to be included for confirmation.

If information of the printer situation in the above electronic mail is, for example, an ink shortage, this electronic mail is an electronic mail for ordering the above cartridge. Furthermore, it is determined at the time of transmitting the electronic mail whether or not a user places an order of the consumable goods.

The standalone PC 20, in which, as set forth above, has been built a program for preparing and transmitting the electronic mail for destination of the consumable goods seller's server 4′ from the information of the printer situation, conducts a process for preparing the electronic mail from the information of the printer situation and the information of the printer being connected hereto.

Furthermore, the standalone PC 20 conducts a communication process for transmitting the prepared electronic mail. In the transmission operation, for example, at the moment when the standalone PC 20 has input the information of the printer situation from the local printer 21, the electronic mail is prepared to display a window for urging transmission of the above electronic mail on the display screen, and, upon a user clicking a transmission button to transmit the electronic mail.

Additionally, instead of displaying a window for urging transmission of the above electronic mail, it is acceptable that an icon for indicating the situation of the printer is displayed on the display screen, upon the above icon being clicked, to display a dialogue box, and in case that a mail icon is present within this dialogue box, to transmit the electronic mail by clicking this mail icon. Upon receiving the electronic mail transmitted from the standalone 20, the consumable goods seller's server 4′ sends back the electronic mail to the user.

In case that the electronic mail from the standalone PC 20 is an order mail, this reply mail is a confirmation mail to the effect that the above order has been received. In the contents of this reply mail are included the contents of a prior user register, and in addition hereto, is included a type, a price, a reception data and a reception site (a registered convenient store) of the cartridge that is necessary to replace, a transaction number for exchange of the product, and so forth.

Moreover, for the electronic mail from the standalone PC 20, the consumable goods seller's server 4′conducts an arrangement process of the consumable goods. In addition, the order by the electronic mail in the fourth system has been related to the cartridge of the printer, but it does not matter that the consumable goods seller's server 4′ gets an order of general computer-related products to provide the related products.

In accordance with the fourth system, the standalone PC 20 that connects to the internet automatically prepares the electronic mail for ordering the substitute at the time of consuming up the consumable goods such as the cartridge and so forth for use in the local printer 21 to transmit it to the consumable goods seller's server 4′, the consumable goods seller's server 4′ sends back the electronic mail for confirmation to conduct an arrangement of the consumable goods, and, accordingly, the advantage is effected that the consumable goods can be quickly and efficiently provided. In addition, in the first to fourth system, with regard to the order received at the consumable goods seller's servers 4 and 4′, in case of having repeatedly received the same order for a given period, for example, within 24 hours, a process is added in which the orders following the second time order is ignored at the servers 4 and 4′.

This is for annulling the orders that the user does not intend, since, in case that the printer is in a bad condition, when the user repeats on/off of the power, at every time, the order is caused to be placed.

In accordance with the present invention, the consumable goods and services providing system is provided in which the server on the consumable goods and services providing side obtains information associated with the apparatus by the network connection to the server that manages the use information of the apparatus to be connected to presume the delivery schedule of the consumable goods or services of the above apparatus, and upon the above delivery schedule date, to conduct a forward procedure of the consumable goods or services, and accordingly, the advantage is effected that the consumable goods and services can be quickly and efficiently provided.

Furthermore, in accordance with the present invention, the consumable goods providing system is provided in which the server on the consumable goods provider side obtains information associated with the apparatus by the network connection to the server that manages the use information of the apparatus to be connected to presume the delivery schedule of the consumable goods of the above apparatus, and upon the above delivery schedule date, to conduct a forward procedure of the suitable substitute recycling consumable goods with the equivalent level in terms of the recycling number to the consumable goods that are scheduled to be delivered, and, accordingly, the advantage is effected that the suitable substitute recycling consumable goods can be quickly and efficiently provided.

Moreover, in accordance with the present invention, the above-mentioned consumable goods providing system is provided in which in case that no suitable substitute recycling consumable goods with the equivalent level are present at the server on the consumable goods providing side, the server on the consumable goods providing side prepares the suitable substitute recycling consumable goods with the equivalent level from the merchant who is in the same line of business and affiliated with it, and accordingly, the advantage is effected that the suitable substitute recycling consumable goods can be quickly and efficiently provided.

In accordance with the present invention, the above-mentioned consumable goods providing system is provided in which in case that no suitable substitute recycling consumable goods with the equivalent level are present at the server on the consumable goods providing side, the server on the consumable goods providing side prepares the same kind of the suitable substitute recycling consumable goods with nearly the same level, and accordingly, the advantage is effected that the suitable substitute recycling consumable goods can be quickly and efficiently provided.

In accordance with the present invention, the above-mentioned consumable goods providing system is provided in which to the consumable goods is attached the record medium such as the ID tag or the bar cord that stores apparatus information, customer information and the recycling number, and accordingly, the advantage is effected that the process management is made easy and the suitable substitute recycling consumable goods can be quickly and efficiently provided.

In accordance with the present invention, the consumable goods providing system is provided, comprising; a printer supervisory server that, upon obtaining the information of the printer situation from the network printer, prepares and transmits the electronic filing document of the situation associated with the above printer; and a server on the consumable goods providing side that receives the transmitted electronic filing document from this printer supervisory server to analyze the contents of the electronic filing document, and that if the above analyzed contents are related to the consumption of the consumable goods at the printer, conducts the arrangement process of the above consumable goods, and, accordingly, the advantage is effected that the consumable goods can be quickly and efficiently provided.

In accordance with the present invention, the above-mentioned consumable goods providing system is provided in which in the information of the printer situation is included information of the serviceman call error at the printer, and in which the server on the consumable goods providing side correspondingly stores the printer and the service station that is located near it, and in case that the analyzed contents is the serviceman call error, transmits the maintenance request of the printer to the terminal apparatus that manages the service station that is located near the above printer, and, accordingly, the advantage is effected that the maintenance of the printer can be quickly and efficiently conducted in addition to the provision of the consumable goods.

What is claimed is:

1. A consumable goods and services providing system comprising;
a server on a consumable goods and services providing side that obtains, by a network connection to a server that manages use information associated with an apparatus connected hereto, use information of said apparatus to presume a delivery schedule of consumable goods or services of the above apparatus, and upon the above delivery schedule date, to conduct a forwarding procedure of the consumable goods or services.

2. The consumable goods and services providing system according to claim 1, wherein the server on the consumable goods and services providing side is a server that presumes a delivery schedule based on a consumption record of the consumable goods or services.

3. The consumable goods and services providing system according to claim 2, wherein the apparatus is a printing machine, wherein the use information is any one of a near end, a empty or a service call, and wherein the server on the consumable goods and services providing side is a server that presumes a delivery schedule by a record based on said near end, said empty or said service call.

4. A consumable goods providing system comprising; a server on a consumable goods providing side that obtains, by a network connection to a server that manages use information associated with an apparatus being connected hereto, use information of said apparatus to presume a delivery schedule of the consumable goods of the above apparatus, and upon the above schedule date, to conduct a forwarding procedure of substitute recycling consumable goods with a equivalent level in terms of a recycling number to the consumable goods that are scheduled to be delivered.

5. The consumable goods providing system according to claim 4, wherein in case that no substitute recycling consumable goods with the equivalent level is present, the server on the consumable goods providing side is a server that prepares and forwards the substitute recycling consumable goods with the equivalent level from a merchant who is in the same line of business and affiliated with it.

6. The consumable goods providing system according to any one of claim 4, wherein in case that no substitute recycling consumable goods with the equivalent level are present, the server on the consumable goods providing side is a server that prepares and forwards the same kind of the substitute recycling consumable goods with nearly a same level.

7. The consumable goods providing system according to any one of claim 4, wherein in case that the consumable goods have completed a specified recycling number, if an agreement is present that a new product is needed, the server on the consumable goods providing side is a server that arranges a new consumable goods.

8. The consumable goods providing system according claim 4, wherein, with regard to the substitute recycling consumable goods, the server on the consumable goods providing side is a server that prepares the substitute recycling consumable goods with the equivalent level or the same kind of the substitute recycling consumable goods with nearly the same level from the consumable goods inventory entrusted by customers.

9. The consumable goods providing system according to any one of claim 1, wherein to the consumable goods is attached a record medium such as an ID tag or a bar code that stores apparatus information, customer information, and recycling number information.

10. The consumable goods providing system according to any one of claim 4, wherein a file for specific customers being disclosed by a customer access, the server on the consumable goods providing side is a server that is able to refer an inventory situation of the consumable goods of the above customer from this disclosed contents.

11. The consumable goods providing system according to any one of claim 4, wherein one group is formed out of a franchiser and many franchisees, wherein a purchase is made within the above group, wherein in case that no product with the equivalent level is present within one franchisee, an inquiry to the other neighboring franchisees is made as to whether or not the product with the equivalent level is present, and wherein in case that no product with the equivalent level is present at several franchisees, a inquiry is made as to the inventory of the same kind of the product with nearly the same level.

12. A consumable goods providing system, comprising; a printer supervisory server that, upon obtaining information of a printer situation from a network printer, prepares and transmits an electronic filing document of the situation associated with the above printer based on said information; and a server on the consumable goods providing side that receives the transmitted electronic filing document from said printer supervisory server to analyze contents of said electronic filing document, and that if the above analyzed contents is related to a consumption of the consumable goods at the printer, conducts an arrangement process of the above consumable goods.

13. The consumable goods providing system according to claim 12, wherein in the information of the printer situation is included information of the near end or the empty, and wherein the server on the consumable goods providing side is a server that stores a past record of said near end and the empty, and that in case that analyzed contents are the near end at the printer, presumes a delivery schedule of the consumable goods according to said past record.

14. The consumable goods providing system according to any one of claim 12, wherein in the information of the printer situation is included information of a serviceman call error at the printer, and wherein the server on the consumable goods providing side correspondingly stores the printer and the service station that is located near it, and in case that the analyzed contents is the serviceman call error, transmits a maintenance request of said printer to a terminal apparatus that manages the service station that is located near the above printer.

15. The consumable goods providing system according to any one of claim 12, wherein to the printer supervisory server is connected via a network a computer that connects a local printer,
said computer being a computer that outputs information of a printing situation of said local printer to said printer supervisory server,
said printer supervisory server being a server that, upon obtaining the information of the printer situation of the local printer being connected to said printer supervisory server, prepares and transmits an electronic filing document of the situation associated with the above printer based on said information.

16. A consumable goods providing system, comprising a server on the consumable goods providing side that receives an electronic filing document transmitted from a standalone computer that prepares an electronic filing document associated with the above printer based on information of a printer situation of a local printer being connected hereto to analyze contents of said electronic filing document, and that if the above analyzed contents are related to consumption of the consumable goods, conducts an arrangement process of the above consumable goods.

17. The consumable goods providing system according to claim 16, wherein, for the received electronic filing document, the server on the consumable goods providing side sends back to the standalone computer an electronic filing document for notifying a price, a reception data and a reception site of the above consumable goods.
